(19) United States
(12) Patent Application Publication
(10) Pub. No.: US 2009/0074968 A1
(43) Pub. Date: Mar. 19, 2009

(54) WET-ON-WET TWO-TONE PAINTING

(75) Inventors: Alyson Marie Dunlop, Royal Oak, MI (US); Aaron M. Fiala, Newport, MI (US); Christopher Anthony Tallon, Louisville, KY (US); Jacob Braslaw, Farmington Hills, MI (US); John Michael Purcell, Livonia, MI (US); Mary Ellen Rosenberger, Northville, MI (US); Stephen Joseph Barrett, Lanesville, IN (US); James Scott Gilland, Northville, MI (US); Samuel A. Smith, Frankfort, KY (US); Timothy S. Young, Bloomfield Hills, MI (US); Warren Phillip Bullock, Taylorsville, KY (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/276,783

(22) Filed: Nov. 24, 2008

Related U.S. Application Data
(62) Division of application No. 10/248,942, filed on Mar. 4, 2003, now abandoned.

(51) Int. Cl. B05D 1/32; B05D 1/38; B05C 13/00; B05C 21/00

(52) U.S. Cl. 427/259; 118/500

(57) ABSTRACT

In at least one embodiment, the present invention relates to a method and system of painting an article having two or more base coats, and to articles prepared in accordance therewith. In at least one embodiment, the method comprises applying a primer composition to a first and second area of the article; applying a first base composition to the first area of the article; curing the primer composition and the first base composition to form a primer and a first base coat; masking at least a portion of the first base coat; applying a second base composition to the second area of the article; removing the masking; applying a clear coat composition to the first and second area of the article; and curing the second base and the clear coat compositions. In at least one embodiment, the article is a vehicle and the compositions are applied via automated spray equipment.

### CROSS-REFERENCE TO RELATED APPLICATIONS

This application is a division of U.S. application Ser. No. 10/248,942 filed Mar. 4, 2003 entitled WET-ON-WET TWO-TONE PAINTING, the entirety of which is incorporated herein by reference.

### BACKGROUND OF THE INVENTION

1. Field of the Invention

The present invention relates to a method and system for providing an article, such as a vehicle, with at least two different appearance paints, and to articles so painted.

2. Background Art

It is often desirable to provide a painted article, such as a vehicle body, that has two or more paints with differing appearances. The appearance of the paints can typically vary in color, hue, and/or shade at two or more different areas of the article. Vehicles painted in this manner are conventionally referred to as “two-tone” vehicles and the process by which they are painted is commonly referred to as a “two-tone” painting process.

The two-tone painting process for a vehicle is typically performed as follows, and is illustrated in FIG. 1. A primer coat composition is applied to the body of the vehicle. This takes place in a first paint booth, typically referred to as a “primer booth.” The vehicle body, prior to the primer coat composition application, is typically prepared for the primer coat composition application in accordance with techniques known to those of ordinary skill in the art. For instance, the vehicle body is provided with an e-coat and/or a phosphate coat. The primer coat composition is then cured to form a primer coat over the vehicle body. The vehicle is then passed through a second paint booth, typically referred to as an “enamel booth” or a “base coat booth” where the vehicle body is then painted, i.e., coated, with a first base coat composition over the cured primer coat. A clear coat composition is typically then applied to the vehicle body over the still wet first base coat composition. The first base coat and clear coat compositions are then cured together in an oven to form a first base coat and a first clear coat over substantially the entire vehicle body.

A main body portion of the vehicle is then masked or covered, typically by what is referred to as a “bag,” to shield the main body portion of the vehicle from paint during a subsequent painting step. This is typically done by securing the bag over the upper portion of the vehicle body, i.e., the portion of the vehicle body that does not require a second base coat application. The vehicle is then sent through a paint booth for a third time to receive a second base coat composition application. The second base coat composition is applied to the unmasked, or second body portion of the vehicle. While the second base coat composition is still wet, a second clear coat composition is typically then applied over the second base coat composition and possibly even some or all of the mask. The vehicle body is then demasked and the second base coat composition and the second clear coat composition are then cured to form a cured second base coat over a portion of the first clear coat and a second clear coat over the second base coat. Under this process, the second base coat is typically referred to as an “accent coat.” The vehicle is then inspected and polished and prepared for shipping.

This conventional “two-tone” painting process has several disadvantages. A first disadvantage is that this conventional process requires three passes through a paint booth—one time through a primer booth and twice through a base coat booth. The conventional process also requires three passes through a curing oven. The conventional process also requires at least two clear coats. The conventional process typically leaves a relatively pronounced witness line (i.e., elevation) between the two tones. Furthermore, the conventional process also uses a relatively cumbersome masking process. The deficiencies in the prior art can have the effect of increasing cost, slowing production, and negatively impacting the aesthetics of vehicles.

Accordingly, it is desirable, and there is a need, to provide two-tone painted articles, and a method and system for painting the articles, that overcome at least one of the deficiencies in the prior art.

### SUMMARY OF THE INVENTION

At least one aspect of the present invention relates to a method of painting an article having two or coat composition to a first and second area of the article, more base coats. The method comprises applying a primer applying a first base coat composition to the first area of the article, and curing the primer coat composition and the first base coat composition to form a cured primer coat and a cured first base coat. The method further comprises masking at least a portion of the first base coat, applying a second base coat composition to the second area of the article, de-masking the first base coat, applying a clear coat composition to the first and second area of the article, and curing the second base coat composition and the clear coat composition to form a cured second base coat and a cured clear coat.

In another aspect of the present invention, the first base coat composition is applied to the first area of the article while the primer coat composition is wet, or at least substantially wet. In this instance, the composition has not yet fully crosslinked and can be removed from the surface by wiping it off with an appropriate solvent, such as isopropanol.

In yet another aspect of the present invention, the first base coat is a first color, and the second base coat is a second color, different from the first color.

In still yet another aspect of the present invention, the clear coat composition is applied to the article while the second base coat composition is wet.

In still further yet another aspect of the present invention, the compositions are applied via automated spray equipment.

In another aspect of the present invention, the present invention relates to an article having two or more base coats applied thereto. The article comprises a substrate, a primer coat cured over the substrate, a first base coat cured over a first portion of the primer coat, a second base coat cured over a second portion of the primer coat, and a clear coat cured over the first base coat and the second base coat. In at least one aspect of the present invention, the first base coat is a first color and the second base coat is a second color, different from the first color. In another aspect of the present invention, the first base coat and the second base coat are substantially the same thickness and are substantially adjacent to one another. In another embodiment, the article is a vehicle.

In another aspect of the present invention, the present invention relates to a two-tone painting system. The system comprises a primer unit, a base unit, and at least one rail for transporting a vehicle through the primer unit and the base unit. The primer unit comprises a primer painting station, a base painting station, and an oven. The base unit comprises a base painting station, a clear coat painting station, and an oven. In at least one embodiment, a masking station is provided between the oven in the primer unit and the base painting station in the base unit. In another embodiment, a demasking station is provided between the base painting station and the clear coat painting station in the base unit. In another embodiment, the rail extends through the primer unit and the base unit. In another embodiment, the primer unit is on a first rail and the base unit is on a second rail.

### BRIEF DESCRIPTION OF THE DRAWINGS

FIG. 1 is a schematic flow diagram representing a prior art process;

FIG. 2 is a vehicle made in accordance with the present invention;

FIG. 3 is a schematic illustration of a view taken along line 3-3 of FIG. 2;

FIG. 4 is a schematic flow diagram representing a process for painting a vehicle in accordance with an embodiment of the present invention;

FIG. 5 is a schematic representation of a cross-section of an article after one of the steps represented in FIG. 4;

FIG. 6 is a schematic representation of a cross-section of an article after another one of the steps represented in FIG. 4;

FIG. 7 is a schematic representation of another one of the steps represented in FIG. 4;

FIG. 8 is a schematic representation of one of the steps represented in FIG. 4;

FIG. 9 is a schematic representation of another embodiment of a part shown in FIG. 8;

FIG. 10 is a schematic representation of a cross-section of an article after another one of the steps represented in FIG. 4;

FIG. 11 is a schematic representation of a cross-section of an article after another one of the steps represented in FIG. 4;

FIG. 12 is a schematic representation of a cross-section of an article after another one of the steps represented in FIG. 4; and

FIG. 13 is a schematic diagram representing a system of the present invention.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention. Moreover, except where otherwise expressly indicated, all numerical quantities in this description and in the claims indicating amounts of material or conditions of reaction and/or use are to be understood as modified by the word “about” in describing the broadest scope of this invention. Practice within the numerical limits stated is generally preferred. Also, unless expressly stated to the contrary: percent, “parts of”, and ratio values are by weight; and the description of a group or class of materials as suitable or preferred for a given purpose in connection with the invention implies that mixtures of any two or more of the members of the group or class may be equally suitable or preferred.

The present invention relates to a two-tone painted article, and to a method and system for two-tone painting an article or substrate. It is contemplated that any paintable substrates can be painted in accordance with the present invention. Examples of articles/substrates that can be painted in accordance with the present invention, include, but are not necessarily limited to, metallic and plastic articles/substrates.

The present invention will be described in connection with two-tone painting a vehicle, however, it is to be understood that articles other than vehicles can be painted in accordance with the present invention.

FIG. 2 schematically illustrates a vehicle 10 made in accordance with the present invention. The vehicle 10 comprises a first body portion 12 and a second body portion 14. The first body portion 12 is covered with a paint that is different in appearance or look than the paint covering the second body portion 14. In certain embodiments, the first body portion 12 is a first color and the second body portion 14 is a second color, different from the first color.

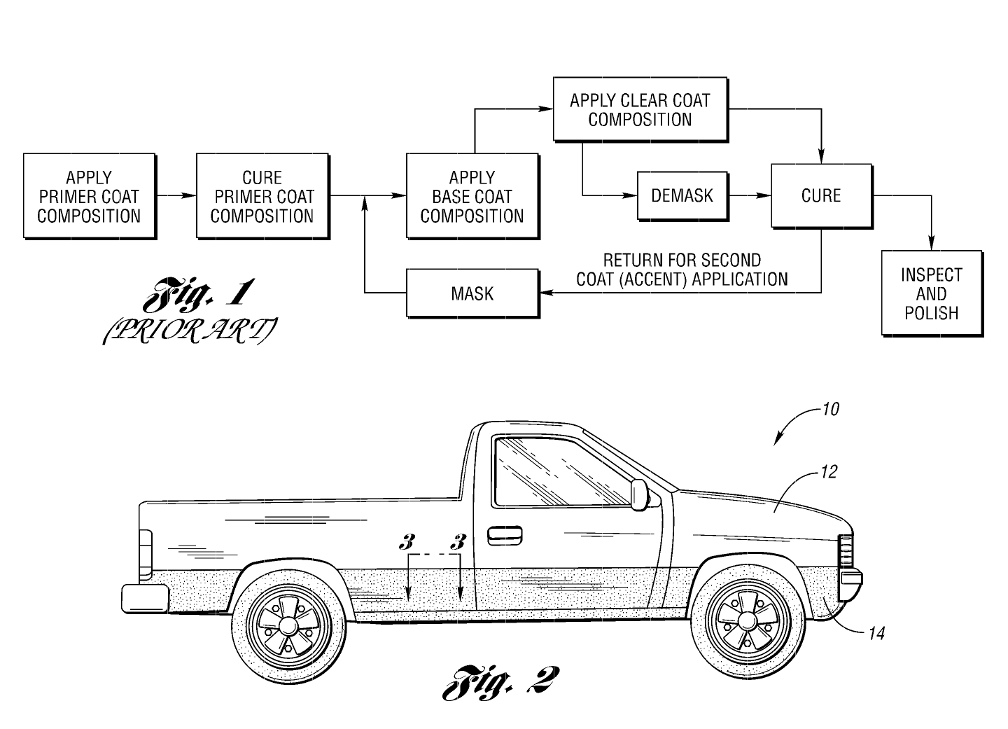

FIG. 3 represents a cross-section of an article two-tone painted in accordance with the present invention. The substrate 30 is coated with a cured primer coat 32. As is readily understood by those of ordinary skill in the art, between the primer coat 32 and the substrate 30 could be known processing coatings such as an e-coat and/or a phosphate coat, or the substrate could have been formed from a pre-coated metal or plastic material. In the embodiment illustrated in FIG. 1, the substrate 30 is a vehicle body. Above a first portion of the primer coat 32 is a first base coat 34 (FIG. 3). In the embodiment illustrated in FIG. 1, the first base coat 34 is over the second body portion 14 of the vehicle 10. Over a second portion of the primer coat 32 is a second base coat 36 (FIG. 3). In the embodiment illustrated in FIG. 1, the second base coat 36 is over the first body portion 12 of the vehicle 10. In FIG. 3, the second base coat 36 is schematically illustrated as being essentially the same thickness and adjacent to the first base coat 34. The coats 34 and 36 being essentially the same thickness helps de-emphasize any witness line. It should be understood, that a minor amount of the first base coat 34 could extend over into the first body portion 12 of the vehicle, in which case, the portion of the first base coat 34 over the first body portion 12 would be covered by second base coat 36. Over the first and second base coats 34 and 36 is a clear coat 38. Each of the coats described and illustrated in FIG. 3 are cured.

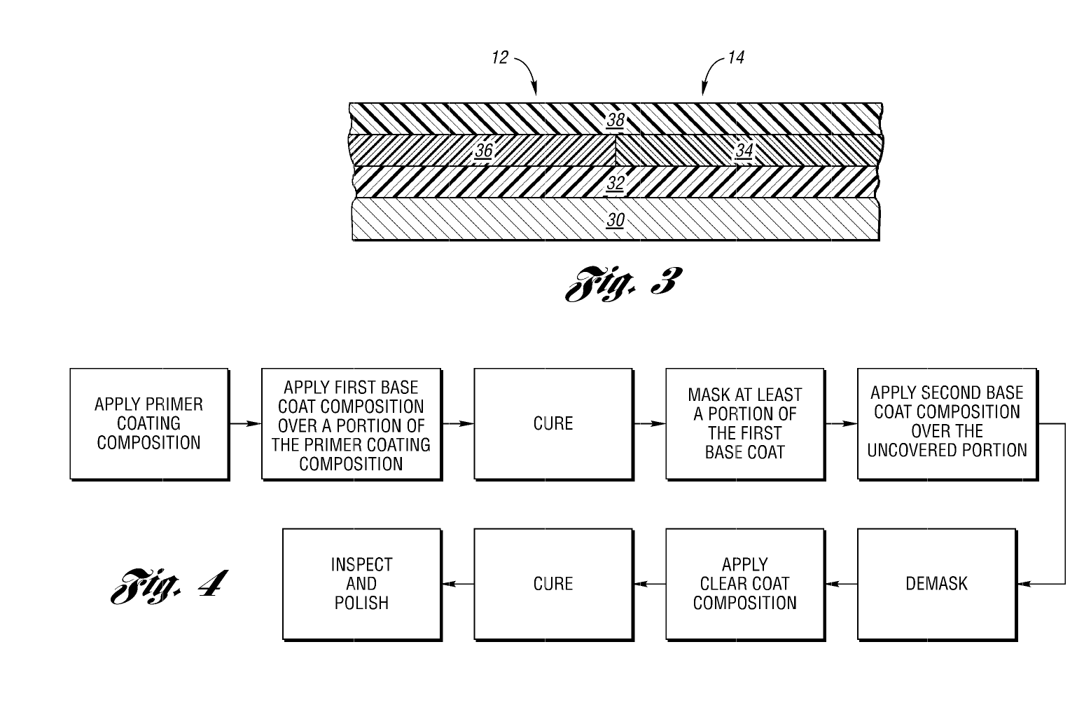

FIG. 4 illustrates a method for two-tone painting an article in accordance with at least one aspect of the present invention.

The article, which in this embodiment is the substrate 30 forming the vehicle body 10, is coated with a primer coat composition 31. The primer coat composition 31 can be applied in a one- or two-step process. The primer coat composition 31 can be applied in any suitable manner known to those of ordinary skill in the art. In the most common embodiment, the primer coat composition 31 will be sprayed onto the vehicle body. The vehicle body, prior to the primer coat composition application is typically prepared for the primer coat composition application in accordance with techniques known to those of ordinary skill in the art. For instance, the vehicle body can be provided with an e-coat and/or a phosphate coat.

In one embodiment, the primer coat composition 31 can be any suitable primer coat composition known to those of ordinary skill in the art. In another embodiment, the primer coat composition 31 has a predetermined rheology to allow the subsequent base coat application to be successful. Employing the use of the primer coat composition 31 of this embodiment can help prevent at least substantial, and potentially any, intermixing between the primer coat composition 31 and the subsequent first base coat composition 33. Substantial intermixing can lead to sliding, sagging, cracking, poor color, poor appearance, and other undesirable paint effects. In this embodiment, the predetermined rheology of the primer coat composition 31 is such that the minimum acceptable sag level of the primer coat composition is at least 2 mils, in other embodiments between 2.1 and 3.0 mils, and in yet other embodiments between 2.25 and 2.6 mils, as measured in accordance with FLTMBI-122-02. The rheology of the primer coat composition 31 can be controlled by adjusting one or more of the viscosity, the solvent blend, or the pigment-to-binder ratio of the primer coat composition 31, or by other such methods as are known by those of ordinary skill in the art. Suitable primer coat compositions 31 comprise rheology modified 2-N-1 primer, available from Dupont-Herberts Automotive, of Troy, Mich., and rheology modified 1-Step primer, available from BASF, of Michigan. FIG. 5 schematically illustrates the article after the primer coat composition 31 has been applied.

After to the primer coat composition 31 has been applied, a first base coat composition 33 is applied over a portion of the primer coat composition 31 while the primer coat composition is still at least substantially wet. The first base coat composition 33 can be applied in either a one- or two-step process. The first base coat composition 33 can be applied in any suitable manner known to those of ordinary skill in the art. In the most common embodiment, the first base coat composition 33 is sprayed onto a portion of the primer coat composition 31.

In certain embodiments, the first base coat composition 33 is applied only to the second body portion 14 of the vehicle 10. In other embodiments, the first base coat composition 33 is applied to the second body portion 14 and a relatively small portion of the first body portion 12. In embodiments where the first base coat composition 33 is applied also to portions of the first body portion 12 of the vehicle 10, the portions of the first body portion 12 where the first base coat composition 33 is applied are primarily adjacent the second body portion 14 of the vehicle 10 with the thickness of the first base coat composition decreasing the further away it is applied from the second body portion 14. The selective deposition of the first base coat composition 33 can be accomplished, when using spraying equipment, by directing the spray equipment to spray the first base coat composition 33 primarily onto the second body portion 14 of the vehicle. When using a spray booth, this can be done by turning off the upper guns while the lower guns are directed at the second body portion 14 of the vehicle 10.

Prior to the application of the first base coat composition 33, the primer coat composition 31 is allowed to flash off for at least 1 second. In certain embodiments, the primer coat composition 31 is allowed to flash off for 1 second to 30 minutes, in other embodiments for 1 second to 3 minutes, and in certain other embodiments for 15 to 60 seconds. The first base coat composition 33 can be any suitable base coat composition that is known to those of ordinary skill in the art. FIG. 6 schematically illustrates the article after the first base coat composition 33 has been applied.

The first base coat composition 33 is then allowed to flash off for at least 10 seconds before the primer coat composition 31 and the first base coat composition are cured in an oven. In certain embodiments, the first base coat composition 33 is allowed to flash off for 1 minute to 120 minutes, in other embodiments the first base coat composition is allowed to flash off for 2 minutes to 60 minutes, in yet other embodiments, the first base coat composition is allowed to flash off for 3 to 30 minutes, and in still yet other embodiments, the first base coat composition is allowed to flash off for 5 to 15 minutes before the vehicle enters a curing oven. After the first base coat composition 33 is allowed to flash off for a period of time, the vehicle enters a curing device, i.e., an oven, where it is exposed to temperatures of about 250° to 350° F. for about 10 to 45 minutes. In other embodiments, the vehicle is exposed to temperatures of about 320° F. for about 15 minutes.

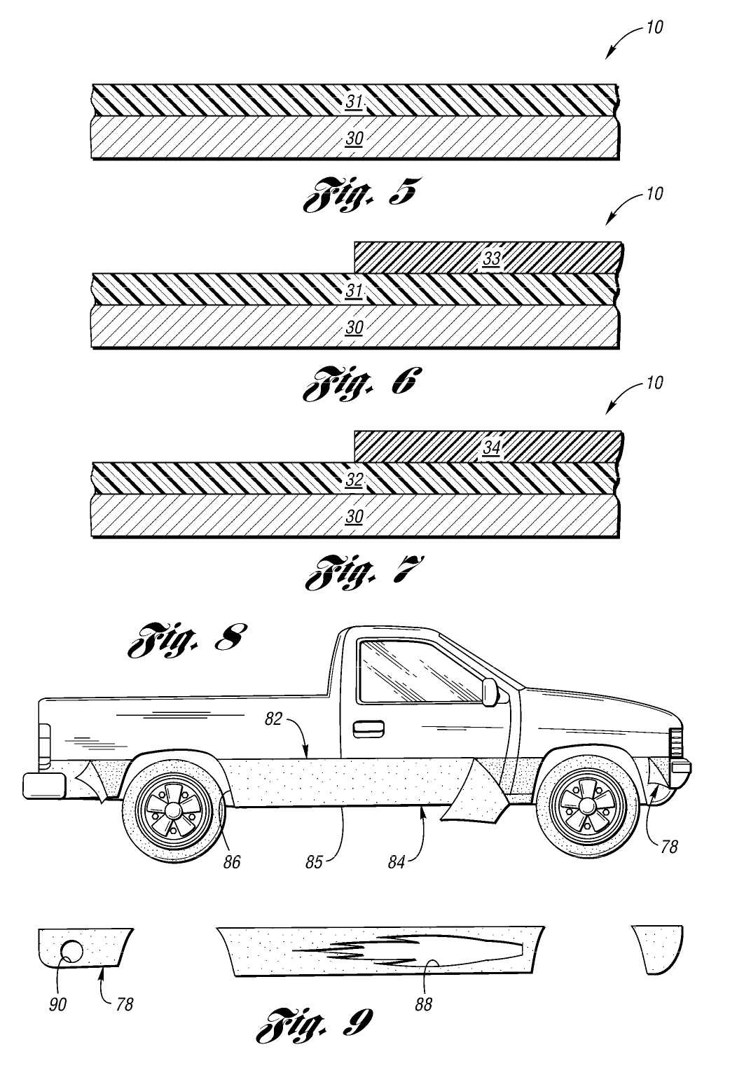

After curing, the primer coat composition 31 forms a cured primer coat 32 over substantially all of the exterior surface of the vehicle body and the first base coat composition 33 forms a cured first base coat 34 over a portion of the primer coat 32. In two-tone paint systems, the first base coat 34 is typically referred to as the “accent coat.” In certain embodiments, the first base coat 34 covers the primer coat 32 at least substantially, over only the second body portion 14 of the vehicle 10, and in other embodiments, cover at least a relatively small portion of the first body portion 12 of the vehicle. In embodiments where a portion of the first body portion 12 is cover by the first base coat 34, the area of the first body portion 12 covered is substantially adjacent the second body portion 14, with the thickness of the first base coat tending to decrease as it extends into the first body portion. FIG. 7 schematically illustrates the article after the primer coat composition 31 and the first base coat composition 33 have been dried.

The second portion 14 of the vehicle is then masked with one or more suitable masks 78. The mask 78 can be any type of material suitable for masking an article/vehicle. Suitable examples of masks include, but are not limited to, paper, plastic sheets, tape, bags, and magnets. In certain embodiments, self-adhesive plastic sheet(s) from Vector Technology of Grand Blanc, Mich. is suitable for use as the mask 78 (FIG. 8). The mask 78 typically comprises several pieces that are contoured to essentially mirror the shape of the second body portion 14 of the vehicle 10.

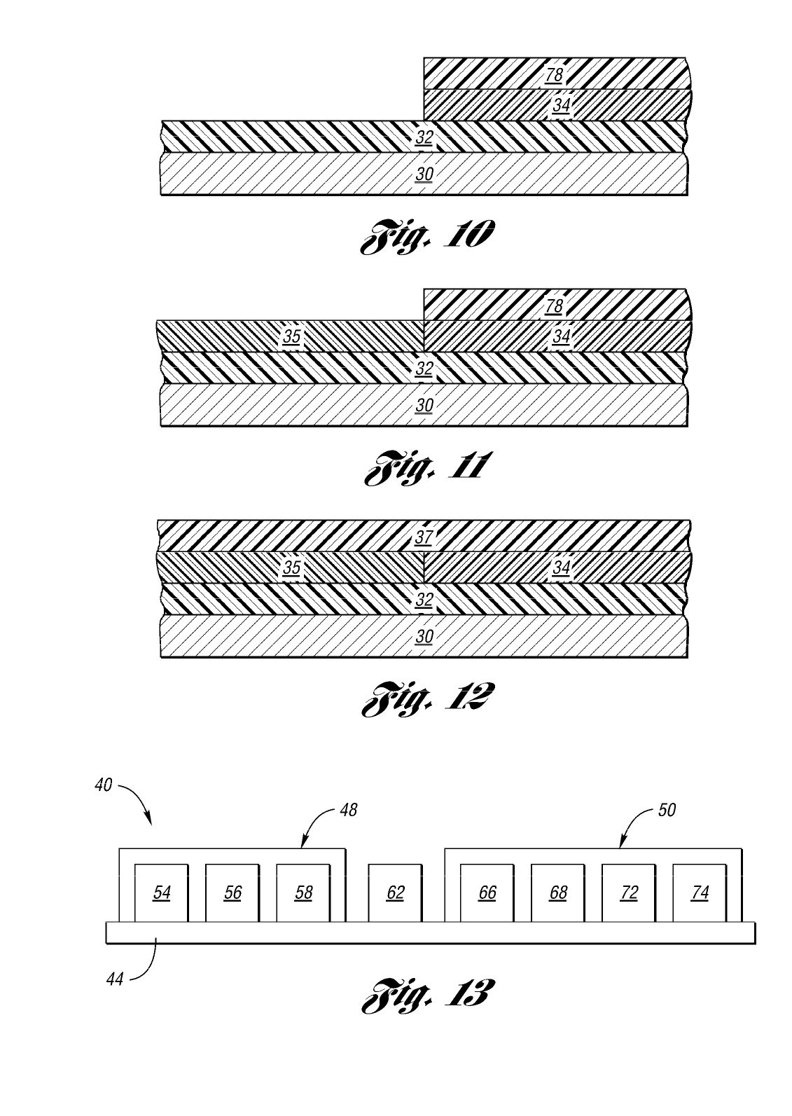

As in the illustrative example of the vehicle 10, the mask 78 comprises several pieces forming an essentially straight upper end, or edge 82, and a lower edge 84 comprising straight 85 and accurate or rounded edges 86 to essentially mirror the bottom edge of the vehicle. In other embodiments (FIG. 9), the mask 78 could have one or more customized shapes to provide vehicles having second body portions having various designs, such as flames 88, and/or cut-outs 90, to name a few. Also, automated masking systems can be employed to help correctly position the mask(s) on each vehicle. Such a system can deposit ink, paint, or other suitable markings on the vehicle to help identify where the mask 78 is to be applied. The mask 78 covers the second body portion 14 of the vehicle 10, which is the area where the accent coating will appear. FIG. 10 schematically illustrates the article after the mask 78 has been applied.

After the vehicle has been masked, a second base coat composition 35 is applied to the vehicle. The second base coat composition 35, in certain embodiments, is applied over the uncovered portion of the primer coat 32 and at least some, if not all, of the masked portion of the vehicle. The second base coat composition 35 can be any suitable base coat composition known to those of ordinary skill in the art, as long as the second base coat is a different color, hue, or shade (or provides a different appearance when cured) than the first base coat. Suitable suppliers of suitable base coat compositions include Dupont-Herberts Automotive and BASF.

The second base coat composition 35 can be applied in a one- or two-step process. The second base coat composition 35 can be applied in any suitable manner known to those of ordinary skill in the art. In the most common embodiment, the second base coat composition 35 is sprayed onto the primer coat 32. FIG. 11 schematically illustrates the article after the second base coat composition 35 has been applied.

The second base coat composition 35 is allowed to flash off before the vehicle is coated with a clear coat composition 37. The flashing off period is typically at least 10 seconds, and in certain embodiments is between 1 minute and 90 minutes, in other embodiments between 2 minutes and 60 minutes, and in yet other embodiments between 3 minutes and 10 minutes.

Prior to the clear coat composition 37 application, the mask 78 is removed from the vehicle. The clear coat composition 37 is then applied over the cured first base coat 34 and the still at least substantially wet second base coat composition 35. The clear coat composition 37 can be applied in a one- or two-step process. The clear coat composition 37 can be applied in any suitable manner known to those of ordinary skill in the art. In the most common embodiment, the clear coat composition 37 is applied via spraying. Any suitable clear coat composition 37 known to one of ordinary skill in the art can be used. Suitable clear coat compositions 37 comprise Gen IV, available from Dupont-Herberts and URO-Clear, available from BASF. FIG. 12 schematically illustrates the article after the clear coat composition 37 has been applied.

After the clear coat composition 37 application, the vehicle is then sent through a curing device, such as an oven so that the second base coat composition 35 and the clear coat composition 37 can be cured. In certain embodiments, the oven is set at a temperature of between about 250° to 300° F. and the vehicle is exposed to the oven between about 10 and 30 minutes. After curing, the second base coat composition 35 forms a cured second base coat 36 over the first portion 12 of the vehicle and the clear coat composition 37 forms a cured clear coat 38 over the entire exterior surface of the vehicle body, i.e., over the cured first and second base coats. (FIG. 3) Because the second body portion 14 of the vehicle is masked during the second base coat composition 35 application, substantially no second base coat 36 is formed over the second body portion 14. After the second base coat 36 and the clear coat 38 have been formed, the vehicle is then inspected and polished and is then ready for shipping.

FIG. 13 schematically illustrates a paint line 40 usable in connection with the present invention. In at least one embodiment, the paint line 40 comprises a rail 44 for transporting vehicles through the line. The paint line 40 includes a primer unit 48 and a base unit 50. The paint line 40 also includes a masking station 62. The primer unit 48, base unit 50, and masking station 62 can all be contained on one rail 44, as shown in FIG. 13, or they could be on separate rails in various configurations. For instance, masking station 62 could be in primer unit 48, or in base unit 50, with each unit 48 and 50 having its own rail. Also, station 62 could be separate from units 48 and 50 and off a rail, or on its own rail.

The primer unit 48 comprises a primer painting station 54 where automated spraying equipment, such as spray guns, can deposit the primer coat composition 31 over the substrate 30, followed by a base coat painting station 56 where automated spray equipment can deposit the first base coat composition 33 over the deposited primer coat composition, followed by an oven 58 where the compositions 31 and 33 can be cured/dried to form coats 32 and 34. The base unit 50 comprises a base coat painting station 66 wherein the second base coat composition 35 can be applied to a portion of the primer coat 32 via automated spray equipment, a demasking station 68 where the mask 78 can be removed from the vehicle, a clear coating station 72 where the clear coat composition 37 can be sprayed over the vehicle, and an oven 74 where the clear coat and second base coat are cured. The painting stations 54, 56, 66, and 72 can comprise typical booth and automated spray gun/nozzle configurations for spraying the desired composition onto the vehicle. The ovens 58 and 74 can comprise typical curing equipment found in conventional oven units.

While the best modes for carrying out the invention have been described in detail, those familiar with the art to which this invention relates will recognize various alternative designs and embodiments for practicing the invention as defined by the following claims. For instance, it should be obvious to those familiar with the art that modifications to the catalysts, other components, and conditions can effect the time and temperatures required to effect curing of the compositions.

What is claimed:

1. A method of painting an article having two or more base coats, said method comprising:
applying a primer coat composition to a first and second area of the article;
applying a first base coat composition to the first area of the article;
curing the primer coat composition and the first base coat composition to form a primer coat and a first base coat;
masking at least a portion of the first base coat;
applying a second base coat composition to the second area of the article;
removing the masking;
applying a clear coat composition to the first and second area of the article; and
curing the second base coat composition and the clear coat composition to form a second base coat and a clear coat.

2. The method of claim 2, wherein the compositions are applied via automated spray equipment.

3. The method of claim 1, wherein the first base coat composition is applied to the first area of the article while the prime coat composition is wet.

4. The method of claim 1, wherein the first base coat is a first color, and the second base coat is a second color, different from the first color.

5. The method of claim 1, wherein the clear coat composition is applied to the article while the second base coat composition is wet and the first base coat is formed.

6. The method of claim 1, wherein the primer coat composition has a sag level of at least 2 mils when measured in accordance with FLTMBI-122-02.

7. The method of claim 1, wherein the primer coat composition has a sag level of between 2.1-3.0 mils when measured in accordance with FLTMBI-122-02.

8. The method of claim 1, wherein the article is a vehicle, and the compositions are applied via automated spray equipment as the vehicle moves down at least one automated spraying line.

9. The method of claim 8, wherein the mask is a self-adhesive plastic member.

10. The method of claim 9, wherein the mask has surfaces for defining a decorative pattern.

11. The method of claim 1, wherein the first base coat is substantially adjacent the second base coat.

12. The method of claim 1, wherein the clear coat extends over both the first and second base coats.

13. The method of claim 1, wherein the first and second base coats extend over the primer coat.

14. A system for two-tone painting an article, said system comprising:
a primer unit for depositing a primer coat and a first base coat on the article;
a base unit for depositing a second base coat and a clear coat on the article; and
at least one rail for transporting a vehicle through the primer unit and the base unit.

15. The system of claim 14, wherein the primer unit comprises a primer painting station, a first base painting station, and a first oven.

16. The system of claim 14, wherein the base unit comprises a second base painting station, a clear coat painting station, and a second oven.

17. The system of claim 16, wherein a masking station is provided between the first oven and the second base painting station.

18. The system of claim 17, wherein a demasking station is provided between the second base painting station and the clear coat painting station.

19. The system of claim 14, wherein the rail extends through the primer unit and the base unit.

20. The system of claim 14, wherein the first base coat is deposited on a first portion of the primer coat, and the second base coat is deposited on a second portion of the primer coat, with the clear coat being deposited on the first and second base coats.
